(19) United States
(12) Patent Application Publication
(10) Pub. No.: US 2017/0149674 A1
(43) Pub. Date: May 25, 2017

(54) SETTING A LIFETIME LIMIT OF A DATA PACKET TO MINIMIZE CONGESTION AND CONTENTION

(71) Applicant: QUALCOMM Incorporated, San Diego, CA (US)

(72) Inventors: Lochan Verma, San Diego, CA (US); Olufunmilola Awoniyi-Oteri, San Diego, CA (US); Vijayalakshmi Raveendran, San Diego, CA (US)

(21) Appl. No.: 14/949,680

(22) Filed: Nov. 23, 2015

(51) Int. Cl. H04L 12/823; H04L 12/801

(52) U.S. Cl. CPC H04L 47/32; H04L 47/12

(57) ABSTRACT

Various aspects provide for determining an amount of time for a data packet at a medium access control (MAC) layer of the first apparatus to reach an application layer of a second apparatus, setting a MAC layer lifetime limit of the data packet based on the determined amount of time for the data packet at the MAC layer of the first apparatus to reach the application layer of the second apparatus, and discarding the data packet when the MAC layer lifetime limit of the data packet is reached. The MAC layer lifetime limit of the data packet comprises a duration of time during which the data packet is suitable for transmission. The MAC layer lifetime limit of the data packet may be different from a MAC layer lifetime limit of another data packet associated with an access category that is the same as the access category with which the data packet is associated. Various other aspects are provided.

### TECHNICAL FIELD

Aspects of the present disclosure relate, generally, to wireless communication and, more particularly, to setting a lifetime limit of a data packet to minimize congestion and contention.

### BACKGROUND

An apparatus may utilize various communication protocols to communicate with another apparatus in a wireless communication network. Such communication may involve the transmission of various data packets. However, some data packets may become unsuitable for transmission after a certain period of time. In other words, some data packets have a limited lifetime. If the lifetime limit of a data packet is set to a duration that is too short, then that data packet might be discarded prematurely (e.g., before the time that the data packet is intended to be rendered at the receiving device). If the lifetime limit of the data packet is set to a duration that is too long, then that data packet might cause congestion (e.g., at the transmission queues) and/or increase contention (e.g., during wireless communication). Features that help to optimize the lifetime limit of the data packet may enhance the efficiency of the communication system and the overall user experience.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the present disclosure provides a method of wireless communication. The method includes determining an amount of time for a data packet at a medium access control (MAC) layer of a first apparatus to reach an application layer of a second apparatus. The method also includes setting a MAC layer lifetime limit of the data packet based on the determined amount of time for the data packet at the MAC layer of the first apparatus to reach the application layer of the second apparatus, wherein the MAC layer lifetime limit of the data packet includes a duration of time during which the data packet is suitable for transmission. The method also includes discarding the data packet when the MAC layer lifetime limit of the data packet is reached.

In another aspect, the present disclosure provides an apparatus configured for wireless communication. The apparatus includes a transceiver, a memory, and at least one processor communicatively coupled to the transceiver and the memory. The at least one processor and the memory are configured to determine an amount of time for a data packet at the MAC layer of the apparatus to reach an application layer of another apparatus. The at least one processor and the memory are further configured to set a MAC layer lifetime limit of the data packet based on the determined amount of time for the data packet at the MAC layer of the apparatus to reach the application layer of the other apparatus, wherein the MAC layer lifetime limit of the data packet includes a duration of time during which the data packet is suitable for transmission. The at least one processor and the memory are further configured to discard the data packet when the MAC layer lifetime limit of the data packet is reached.

In yet another aspect, the present disclosure provides a computer-readable medium storing computer-executable code comprising instructions configured for determining an amount of time for a data packet at the MAC layer of a first apparatus to reach an application layer of a second apparatus. The instructions are further configured for setting a MAC layer lifetime limit of the data packet based on the determined amount of time for the data packet at the MAC layer of the first apparatus to reach the application layer of the second apparatus, wherein the MAC layer lifetime limit of the data packet includes a duration of time during which the data packet is suitable for transmission. The instructions are further configured for discarding the data packet when the MAC layer lifetime limit of the data packet is reached.

In a further aspect, the present disclosure provides another apparatus configured for wireless communication. The apparatus includes means for determining an amount of time for a data packet at the MAC layer of a first apparatus to reach an application layer of a second apparatus. The apparatus also includes means for setting a MAC layer lifetime limit of the data packet based on the determined amount of time for the data packet at the MAC layer of the first apparatus to reach the application layer of the second apparatus, wherein the MAC layer lifetime limit of the data packet includes a duration of time during which the data packet is suitable for transmission. The apparatus also includes means for discarding the data packet when the MAC layer lifetime limit of the data packet is reached.

These and other aspects of the present disclosure will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating an example of various apparatuses in a communication network according to aspects of the present disclosure.

FIG. 2 is a diagram illustrating an example of various protocol layers of a communication system according to aspects of the present disclosure.

FIG. 3 is a diagram illustrating another example of various protocol layers of a communication system according to aspects of the present disclosure.

FIG. 4 is a diagram illustrating an example of a timeline according to aspects of the present disclosure.

FIG. 5 is a diagram illustrating an example of various methods and/or processes according to aspects of the present disclosure.

FIG. 6 is a diagram illustrating another example of various methods and/or processes according to aspects of the present disclosure.

FIG. 7 is a diagram illustrating an example of a hardware implementation of an apparatus according to aspects of the present disclosure.

### DESCRIPTION OF SOME EXAMPLES

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

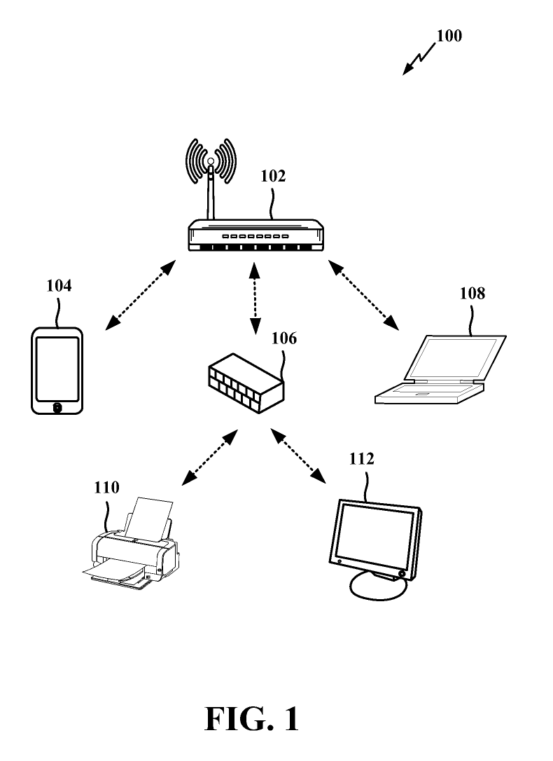

FIG. 1 is a diagram 100 illustrating an example of various apparatuses in a communication network. In this example, the communication network includes various apparatuses, such as an access point (AP) 102, a mobile device 104, a hub 106, a laptop computer 108, a printer 110, and a monitor 112. The AP 102 is configured to communicate with downstream apparatuses (e.g., mobile device 104, hub 106, laptop computer 108). One of ordinary skill in the art will understand that the AP 102 may be referred to as a base station, a base transceiver station, a radio base station, a radio transceiver, a node, a relay, and/or any other suitable terminology without deviating from the scope of the present disclosure. The hub 106 is configured to communicate with upstream apparatuses (e.g., AP 102) and downstream apparatuses (e.g., printer 110, monitor 112). One of ordinary skill in the art will understand that any one or more of the apparatuses downstream of the AP 102 may be referred to as a station (STA), terminal, and/or any other suitable terminology without deviating from the scope of the present disclosure. In some configurations, the STA may be an Enhanced Distributed Channel Access (EDCA) station. In some configurations, the STA may be a Hybrid Coordination Function Controlled Channel Access (HCCA) station. One of ordinary skill in the art will understand that any apparatus downstream of the AP 102 may include, but is not limited to, a cellular phone, a smart phone, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, a session initiation protocol phone, a laptop, a notebook, a netbook, a smartbook, a personal digital assistant, a satellite radio, a global positioning system device, a multimedia device, a video device, a digital audio player, a camera, a game console, an entertainment device, a vehicle component, a wearable computing device (e.g., a smart watch, glasses, a health or fitness tracker, etc.), an appliance, a sensor, a vending machine, and/or any other suitable apparatus.

The apparatuses in the communication network may utilize at least some algorithms and/or protocols corresponding to a standard promulgated by Institute of Electrical and Electronics Engineers (IEEE), such as IEEE 802.11. One of ordinary skill in the art will understand that the communication network may include fewer or additional apparatuses relative to the apparatuses illustrated in FIG. 1 without deviating from the scope of the present disclosure. One of ordinary skill in the art will understand that the example illustrated in FIG. 1 is provided for illustrative purposes and is not intended to limit the scope of the present disclosure. A communication network may implement alternative configurations without deviating from the scope of the present disclosure.

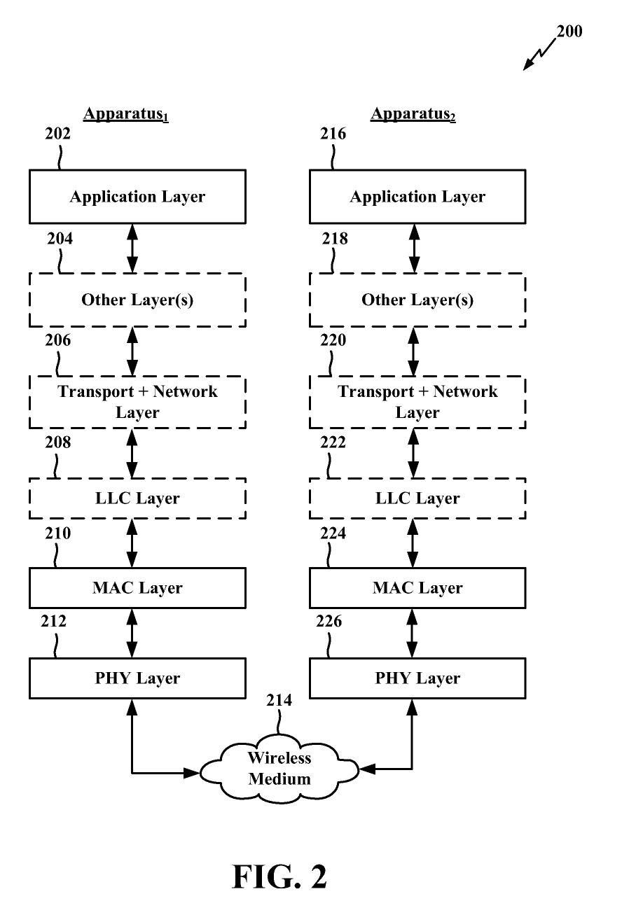

FIG. 2 is a diagram 200 illustrating an example of various protocol layers of a communication system. The protocol layers illustrated in FIG. 2 may be utilized by various apparatuses without deviating from the scope of the present disclosure. In some configurations, Apparatus₁ may be the AP 102 described above with reference to FIG. 1. In some configurations, Apparatus₂ may be any one or more the STAs (e.g., mobile device 104, hub 106, laptop computer 108, printer 110, monitor 112) described above with reference to FIG. 1

The protocol layers illustrated in FIG. 2 shall not be construed as a limitation of the present disclosure. One of ordinary skill in the art will understand that fewer, additional, and/or alternative protocol layers may be implemented without deviating from the scope of the present disclosure. For instance, various protocol layers not illustrated in FIG. 2 may exist between any of the layers illustrated in FIG. 2 without deviating from the scope of the present disclosure. One of ordinary skill in the art will also understand that such protocol layers may be utilized in various configurations, even if not illustrated in FIG. 2, without deviating from the scope of the present disclosure. In some configurations, as illustrated in FIG. 2, the protocol layers may include application layers 202, 216, transport and network layers 206, 220, logical link control (LLC) layers 208, 222, medium access control (MAC) layers 210, 224, physical layers 212, 226, and/or various other layers 204, 218. An example of such other layers 204, 218 is a protocol access layer (PAL), such as a media agnostic (MA) universal serial bus (USB) PAL, which can enable connectivity between a USB host and one or more USB devices.

The transport and network layers 206, 220 may facilitate the flow of the data traffic to one or more devices via Internet protocol (IP) links. For example, Apparatus₁ and Apparatus₂ may be separated by an IP network. Apparatus₁ and Apparatus₂ may be direct clients of a transmission control protocol (TCP). The data traffic may be packaged into IP datagrams and delivered through TCP connections. However, the transport and network layers 206, 220 may not exist in all configurations of the present disclosure, such as when the data traffic is not being transmitted from the host to the device via IP links. The transport and network layers 406, 220 may also perform other functions and/or include other features not described herein without deviating from the scope of the present disclosure.

The LLC layers 208, 222 may be the upper sublayer of a data link layer. The LLC layers 208, 222 may provide multiplexing mechanisms to enable various network protocols to coexist within a multipoint network and to be transported over the same network medium. The LLC layers 208, 222 may also control data flows as well as provide error management. The LLC layers 208, 222 may also perform other functions and/or include other features not described herein without deviating from the scope of the present disclosure. The LLC layers 208, 222 interface between the network layers (e.g., transport and network layers 206, 220) and the MAC layers (e.g., MAC layers 210, 224).

The MAC layers 210, 224 may be the lower sublayer of the data link layer. The MAC layers 210, 224 may provide addressing and channel access control mechanisms that enable various terminals or network nodes to communicate within a multiple-access network having a shared medium (e.g., a wireless medium according to IEEE 802.11). The MAC layers 210, 224 may emulate a full-duplex logical communication channel in a multi-point network, and such a channel may provide unicast, multicast, and/or broadcast communication service(s). The MAC layers 210, 224 may also perform other functions and/or include other features not described herein without deviating from the scope of the present disclosure. The MAC layers 210, 224 may interface between the LLC layers 208, 222 and the network PHY layers 212, 226.

The PHY layers 212, 226 may include network hardware transmission technologies. The PHY layers 212, 226 may provide the means for transmitting data traffic. The PHY layers 212, 226 may provide an electrical, mechanical, and/or procedural interface to the wireless medium 214. The PHY layers 212, 226 may specify various attributes of the data traffic, such as the frequency on which the data traffic is transmitted, the modulating scheme of the data traffic, and other related attributes of the data traffic. The PHY layers 212, 226 may also perform other functions and/or include other features not described herein without deviating from the scope of the present disclosure. The PHY layers 212, 226 may transmit the data traffic to another apparatus via the wireless medium 214. The wireless medium 214 may be utilized in accordance with IEEE 802.11. The wireless medium 214 may also be utilized in accordance with various other communication standards. The wireless medium 214 may interface between the PHY layer 212 of Apparatus₁ and the PHY layer 226 of Apparatus₂.

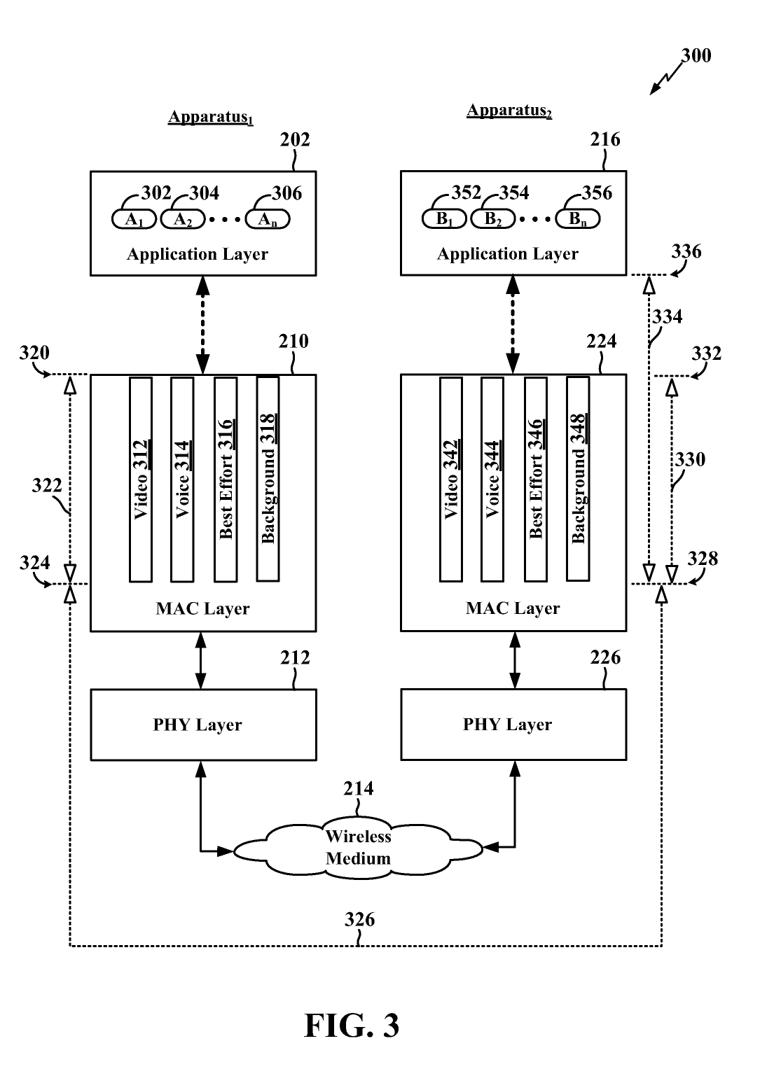

FIG. 3 is a diagram 300 illustrating another example of various protocol layers of a communication system. Various aspects pertaining to the layers illustrated in FIG. 3 is described above with reference to FIG. 2 and therefore will not be repeated. At the application layer 202 of Apparatus₁, Apparatus₁ may generate one or more data packets (e.g., A₁ 302, A₂ 304, Aₙ 306) for transmission to and rendering at Apparatus₂. In some configurations, these data packets (e.g., A₁ 302, A₂ 304, Aₙ 306) may be referred to as MAC Service Data Unit (MSDU) data packets without deviating from the scope of the present disclosure. These data packets may originate at the application layer 202 of Apparatus₁ and flow through various protocol layers (as described in greater detail above with reference to FIG. 2) and eventually arrive at the MAC layer 210 of Apparatus₁. At the MAC layer 210 of Apparatus₁, the data packets will reach the beginning 320 of one or more queues. Each data packet may be assigned to a queue based on the access category or stream identifier (ID) associated with that specific data packet. A stream ID may refer to a numerical value assigned or associated with the data packet. Each stream ID may uniquely identify a stream of data with which the data packet is associated or to which the data packet is assigned. An access category may refer to the general type, class, characteristic, and/or content of the data packet. Non-limiting examples of various access categories are illustrated in FIG. 3 and included video 312, voice 314, best effort 316, and background 318. For instance, if a particular data packet is associated with an access category of video 312, then that particular data packet will be included at the beginning of the queue associated with that access category (e.g., video 312).

One of ordinary skill in the art will understand that the term ‘access category’ may be referred to using another term without deviating from the scope of the present disclosure. As an example, the term ‘access category’ may also be referred to as a ‘traffic category’ without deviation from the scope of the present disclosure. One of ordinary skill in the art will also understand that the term ‘stream ID’ may be referred to using another term without deviating from the scope of the present disclosure. As an example, the term ‘stream ID’ may also be referred to as a ‘traffic stream’ without deviation from the scope of the present disclosure. In some configurations, the term(s) ‘access category’ and/or ‘traffic category’ may apply to EDCA stations. In some configurations, the term(s) ‘stream ID’ and/or ‘traffic stream’ may apply to HCCA stations. One of ordinary skill in the art will understand that ‘access category’ and/or ‘traffic category’ can refer to similar concepts as ‘stream ID’ and/or ‘traffic stream’ without deviating from the scope of the present disclosure.

The amount of time that a particular data packet spends in the path 322 from the beginning 320 of a queue to the end 324 of that queue at the MAC layer 210 may depend upon the amount of other data also in that particular queue. For example, if the queue associated with the access category of video 312 is congested with other data packets (that arrived before A₁ 302), then A₁ 302 will spend more time in the path 320 from the beginning 320 of the queue to the end 324 of the queue than it would have otherwise. Conversely, if the queue associated with the access category of video 312 is free from any other data packets (that arrived before A₁ 302), then A₁ 302 will spend less time in the path 320 from the beginning 320 of the queue to the end 324 of the queue than it would have otherwise. Accordingly, the amount of time for a data packet to flow from the beginning 320 of a queue to the end 324 of the queue at the MAC layer 210 of Apparatus₁ can vary based on one or more factors.

After reaching the end 324 of the queue at the MAC layer 210 of Apparatus₁, the data packet will flow through a path 326 that may include (without exclusion) (i) any remaining portions of the MAC layer 210 of Apparatus₁, (ii) the PHY layer 212 of Apparatus₁, and (iii) the wireless medium 214 separating the PHY layer 212 of Apparatus₁ and the PHY layer 226 of Apparatus₂, as illustrated in FIG. 3. Eventually, the data packet reaches the beginning 328 of a queue at the MAC layer 224 of Apparatus₂. At the MAC layer 224 of Apparatus₂, the data packets will reach the beginning 328 of one or more queues. Each data packet may be assigned to a queue based on the access category or stream identifier (ID) associated with that specific data packet. Non-limiting examples of various access categories are illustrated in FIG. 3 and included video 342, voice 344, best effort 346, and background 348. For example, if a particular data packet is associated with an access category of video 342, then that particular data packet will be included at the beginning 328 of the queue associated with that access category (e.g., video 342).

The amount of time that a data packet spends in the path 330 from the beginning 328 of a queue to the end 332 of that queue at the MAC layer 224 may depend upon the amount of other data also in that particular queue as well as various other factors. For example, if the queue associated with the access category of video 342 is congested with other data packets (that arrived before A₁ 302), then A₁ 302 will spend more time in the path 330 from the beginning 328 of the queue to the end 332 of the queue than it would have otherwise. Conversely, if the queue associated with the access category of video 342 is free from any other data packets (that arrived before A₁ 302), then A₁ 302 will spend less time in the path 330 from the beginning 328 of the queue to the end 332 of the queue than it would have otherwise. Accordingly, the amount of time for a data packet to flow from the beginning 328 of a queue to the end 332 of the queue at the MAC layer 224 of Apparatus₂ can vary based on one or more factors.

After reaching the end 332 of the queue at the MAC layer 224 of Apparatus₂, the data packet will flow through various other protocol layers (as described in greater detail above with reference to FIG. 2) and eventually arrive at the beginning 336 of the application layer 216. The path 334 from the beginning 328 of the queue at the MAC layer 224 of Apparatus₂ to the beginning 336 of the application layer 216 of Apparatus₂ can vary based on various factors, such as the amount of congestion at the MAC layer 224 as well as various other layers (e.g., LLC layer 222, transport and network layer 220, and other layer(s) 218). After reaching the beginning 336 of the application layer 216 of Apparatus₂, the data packet may be rendered (e.g., as data packets B₁ 352, B₂ 354, Bₙ 356).

In many configurations, data packets (e.g., A₁ 302, A₂ 304, Aₙ 306) originating at Apparatus₁ may be assigned a lifetime limit upon entering the MAC layer 210 of Apparatus₁. Generally, the term ‘lifetime limit’ refers to a duration of time during which the data packet is suitable for transmission. For example, a timer may be started at the time that the data packet enters the MAC layer 210 of Apparatus₁. That timer may count backwards until reaching a value of zero. The starting value of the timer (before beginning to count backwards to a value of zero) may be referred to as the lifetime limit. The lifetime of the data packet expires once the timer reaches a value of zero. The data packet may not be suitable for transmission after the lifetime limit has expired.

The concept of a lifetime limit may be implemented with respect to various types of protocol layers without deviating from the scope of the present disclosure. Although many examples described herein may refer to a MAC layer lifetime limit, one of ordinary skill in the art will understand that the concept of a lifetime limit is not necessarily limited to a MAC layer. Accordingly, the concepts described herein with respect to a lifetime limit (e.g., a MAC layer lifetime limit) may additionally or alternatively be implemented with respect to a physical (PHY) layer lifetime limit, an Internet protocol (IP) layer lifetime limit, and/or various other suitable types of lifetime limits without deviating from the scope of the present disclosure.

One of ordinary skill in the art will understand that the term ‘suitable’ may be used interchangeably with similar terms (e.g., valuable, useful, acceptable, good, valid, etc.) without deviating from the scope of the present disclosure. In some examples, a data packet may be characterized as suitable for transmission (e.g., from Apparatus₁ to Apparatus₂) when the data in the data packet is not expired or otherwise too old for rendering at the destination (e.g., Apparatus₂). When the data in the data packet is expired or otherwise too old for rendering at the destination (e.g., Apparatus₂), the data that would be rendered at the destination (e.g., Apparatus₂) would be unsynchronized, uncoordinated, or otherwise irregular in relation to other data also being rendered at the destination (e.g., Apparatus₂).

One of ordinary skill in the art will understand that the term ‘lifetime limit’ may be interchangeable with various other suitable terms without deviating from the scope of the present disclosure. For example, the term ‘lifetime limit’ (e.g., MAC layer lifetime limit) may be interchangeable with the term ‘delay bound’ without deviating from the scope of the present disclosure. In some configurations, the term ‘lifetime limit’ (e.g., MAC layer lifetime limit) may apply to EDCA stations. In some configurations, the term ‘delay bound’ may apply to HCCA stations. However, one of ordinary skill in the art will understand that these terms can refer to similar concepts without deviating from the scope of the present disclosure.

In some conventional communication systems, the lifetime limit (e.g., MAC layer lifetime limit) may be set for a group of data packets based on the particular access category associated with those data packets. For example, some conventional communication systems may assign the same lifetime limit (e.g., MAC layer lifetime limit) for all data packets associated with the access category of video 312, 342. The lifetime limit (e.g., MAC layer lifetime limit) assigned for the data packets associated with the access category of video 312, 342 may be different from the lifetime limit (e.g., MAC layer lifetime limit) assigned for the data packets associated with the access category of voice 314, 344; however, with respect to a specific access category, some conventional communication systems may assign the same lifetime limit (e.g., MAC layer lifetime limit). In other words, conventional communication systems may not assign a different lifetime limit (e.g., MAC layer lifetime limit) for two (or more) data packets associated with the same access category.

In some conventional communication systems, the lifetime limit (e.g., MAC layer lifetime limit) may be set for a group of data packets based on the particular steam ID associated with those data packets. Generally, the stream ID may include information that identifies the traffic stream with which the data packets (e.g., A₁ 302, A₂ 304, Aₙ 306) are associated at the application layer 202 of Apparatus₁. For example, some conventional communication systems may assign the same application expiration time for all data packets associated with a particular stream ID. The lifetime limit (e.g., MAC layer lifetime limit) assigned for the data packets associated with that particular stream ID may be different from the lifetime limit (e.g., MAC layer lifetime limit) assigned for the data packets associated with another stream ID; however, with respect to a particular stream ID, conventional communication systems may assign the same lifetime limit (e.g., MAC layer lifetime limit). In other words, conventional communication systems may not assign different application expiration times for two (or more) data packets associated with the same stream ID.

However, as network and traffic conditions change over time, the amount of time that a data packet will take to travel the paths 322, 326, 334 from the beginning 320 of a queue at the MAC layer 210 to the beginning 336 of the application layer 216 of Apparatus₂ can vary. As an example, when an abundance of video data packets flood the queue for video 312, the queue for video 312 will become congested and, consequently, the amount of time that the data packet takes to travel the path 322 from the beginning 320 to the end 324 of the queue at the MAC layer 210 can vary. As another example, congestion at the PHY layer(s) 212, 226 can affect the amount of time for the data packet to travel the path 326 from the end 324 of the queue at the MAC layer 210 of Apparatus₁ to the beginning 328 of the queue at the MAC layer 224 of Apparatus₂. As yet another example, contention when accessing the wireless medium 214 can also affect the amount of time for the data packet to travel that path 326. As a further example, congestion at a queue at the MAC layer 224 of Appartus₂ can affect the amount of time for the data packet to travel from the beginning 328 to the end 332 of that queue.

As described above, network and traffic conditions change over time, thereby affecting the amount of time that a data packet will take to travel the paths 322, 326, 334 from the beginning 320 of a queue at the MAC layer 210 of Apparatus₁ to the beginning 336 of the application layer 224 of Apparatus₂ can vary. Nevertheless, conventional communication systems set the lifetime limit (e.g., MAC layer lifetime limit) without considering the foregoing factors. Because conventional communication systems may not consider at least some of the above factors that can affect the amount of time for the data packet to travel from the beginning 320 of the MAC layer 210 of Apparatus₁ to the beginning 336 of the application layer 216 of Apparatus₂, there may exist opportunities for enhancements to conventional communication systems and the overall user experience.

In comparison with conventional communication systems, various aspects of the present disclosure include determining an amount of time for a data packet at the MAC layer of an apparatus to reach an application layer of another apparatus and setting the lifetime limit (e.g., MAC layer lifetime limit) of the data packet based on that determined amount of time. For example, Apparatus₁ may determine an amount of time for a data packet at the MAC layer 210 to reach an application layer 216 of Apparatus₂. Apparatus₁ may then set a lifetime limit (e.g., MAC layer lifetime limit) of the data packet based on that determined amount of time. The term ‘lifetime limit’ is described in greater detail above and therefore will not be repeated. When the lifetime limit (e.g., MAC layer lifetime limit) of the data packet is reached, then the data packet may be discarded. Generally, the term(s) ‘discard’ and/or ‘discarding’ may refer to deletion, dumping, canceling, disposal, elimination, abandonment, rejection, exclusion, omission, and/or various other suitable terms without deviating from the scope of the present disclosure. Discarding data packets once their lifetime limit (e.g., MAC layer lifetime limit) has been reached helps to reduce contention and congestion in the overall system. Contention and congestion in the overall system can be reduced because discarded packets cannot congest transmission queues (e.g., queues at the MAC layer 210 of Apparatus₁) and are not transmitted, thereby reducing contention. If the lifetime limit (e.g., MAC layer lifetime limit) of a data packet is too long (e.g., longer than the period during which it is suitable for transmission), then the likelihood of that data packet causing congestion and contention increases. Accordingly, the likelihood of congestion and contention caused by that data packet may be reduced in certain circumstances by determining a reduced lifetime limit (e.g., MAC layer lifetime limit) for that data packet (e.g., A₁ 302), as described in greater detail below.

In various aspects of the present disclosure, Apparatus₁ may determine the lifetime limit (e.g., MAC layer lifetime limit) of a data packet by (i) calculating a difference between an application expiration time and a current system time, and (ii) reducing that calculated difference (between the application expiration time and the current system time) by the amount of time for the data packet at the MAC layer of the first apparatus to reach the application layer of the second apparatus. Generally, the term ‘application expiration time’ refers to a specific point in time at which the data packet is intended to be rendered (e.g., processed, displayed, played, etc.) at the application layer of the destination (e.g., Apparatus₂). The application expiration time may be determined utilizing various techniques without deviating from the scope of the present disclosure. As an example, the application expiration time may be included in a portion of the data packet (e.g., the header). As another example, Apparatus₁ may determine the application expiration time based on the type and/or content of the data packet. For example, the data packet may be a video data packet, and Apparatus₁ may automatically set the same application expiration time for all video data packets. As yet another example, the application expiration time may be received from another apparatus (e.g., Apparatus₂). One of ordinary skill in the art will understand that the term ‘application expiration time’ may sometimes be referred to utilizing other words without deviating from the scope of the present disclosure. For instance, with respect to video data packets and/or audio data packets, this term may sometimes be referred to as ‘presentation time stamp’ (PTS).

The difference between an application expiration time (e.g., PTS) and the current system time can be represented by the following mathematical expression: PTS−SYS_Time_{Current}, wherein “PTS” refers to the application expiration time (e.g., PTS), and wherein “SYS_Time_{Current}” refers to the current system time (e.g., network time) when the data packet enters the MAC layer 210. The current system time may be determined utilizing various techniques without deviating from the scope of the present disclosure. As an example, Apparatus₁ may receive the current system time from a network (e.g., a timing server) with which Apparatus₁ can communicate. As another example, Apparatus₁ may retrieve the current system time from its own internal timing circuit and/or clock. As yet another example, Apparatus₁ may receive the current system time from another apparatus (e.g., Apparatus₂). The amount of time for the data packet at the MAC layer of an apparatus to reach the application layer of another apparatus can be represented by the following mathematical equation: Queue_Time_{MAC}+RTT_{MAC}+Time_Loss_{Misc}, wherein “Queue_Time_{MAC}” refers to the amount of time for the data packet to travel the aforementioned path 322, wherein “RTT_{MAC}” refers to the amount of time for the data packet to travel the aforementioned path 326 (e.g., including any time for the return of any acknowledgement message from Apparatus₂ to Apparatus₁), and wherein “Time_Loss_{Misc}” refers to the amount of time for the data packet to travel the aforementioned path 334. (As described above, the amount of time for the data packet to travel the aforementioned path 334 includes the amount of time for the data packet to travel the aforementioned path 330.) Accordingly, the lifetime limit (e.g., MAC layer lifetime limit) (“MSDU_{Lifetime}_{_}_{Limit}”) of a data packet can be determined utilizing the following mathematical expression: MSDU_{Lifetime}_{_}_{Limit}=PTS−SYS_Time_{Current}−Queue_Time_{MAC}−RTT_{MAC}−Time_Loss_{Misc}, which is hereinafter referred to as “Equation 1.” One of ordinary skill in the art will understand that some of these variables (e.g., Queue_Time_{MAC},RTT_{MAC},Time_Loss_{Misc}) may be moving averages without deviating from the scope of the present disclosure.

The following example contains numerical values for illustrative purposes and is not intended to limit the scope of the present disclosure. For example, the current system time (SYS_Time_{Current}) (when the data packet enters the MAC layer 210 of Apparatus₁) is 10:00:00:000 AM, and the application expiration time (PTS) is 10:00:01:000 AM, which means that the data packet is intended to be rendered at the application layer 224 of Apparatus₂ within 1000 milliseconds (ms) after the entering the MAC layer 210 of Apparatus₁. In this example, the amount of time for the data packet to travel the aforementioned path 322 (Queue_Time_{MAC}) is 50 ms, the amount of time for the data packet to travel the aforementioned path 326 (RTT_{MAC}) is 150 ms, and the amount of time for the data packet to travel the aforementioned path 334 (Time_Loss_{Misc}) is 50 ms, which means that the total amount of time for the data packet to travel from the beginning 320 of the queue at the MAC layer 210 of Apparatus₁ to the beginning 336 of the application layer 216 of Apparatus₂ is 250 ms. This means that the data packet must leave the MAC layer 210 within 750 ms after arriving at the MAC layer 210. Otherwise, the data packet will not arrive at the application layer 216 by the application expiration time (1000 ms later). In other words, the data packet will not arrive at the application layer 216 by the application expiration time (10:00:01:000 AM) if the data packet does not leave the MAC layer 210 by 10:00:00:750 AM. Accordingly, the lifetime limit (e.g., MAC layer lifetime limit) can be set to 750 ms, thereby potentially discarding the data packet sooner than it might be discarded otherwise. A discarded data packet reduces congestion and contention in the communication system. As described above, contention and congestion in the communication system can be reduced because discarded packets cannot congest transmission queues (e.g., queues at the MAC layer 210 of Apparatus₁) and are not transmitted, thereby reducing contention.

According to various aspects of the present disclosure, the lifetime limit (e.g., MAC layer lifetime limit) is set on a per-packet basis. In comparison to conventional communication systems (which set the lifetime limit of groups of data packets (e.g., based on the access group and/or stream ID) with which those groups of data packets are associated), aspects of the present disclosure set the lifetime individually for each data packet. Furthermore, because the lifetime limit (e.g., MAC layer lifetime limit) is not set strictly based on the access category and/or stream ID with which the data packet is associated (as is performed in conventional communication systems), it is possible for the lifetime limit (e.g., MAC layer lifetime limit) of two data packets associated with the same access category to be assigned different values. For example, referring to FIG. 3, a first data packet may be assigned a different lifetime limit (e.g., MAC layer lifetime limit) than the lifetime limit (e.g., MAC layer lifetime limit) assigned to a second data packet (e.g., (e.g., A₂ 304), even if first data packet and the second data packet (e.g., A₂ 304) are both associated with the same access category and/or the same stream ID.

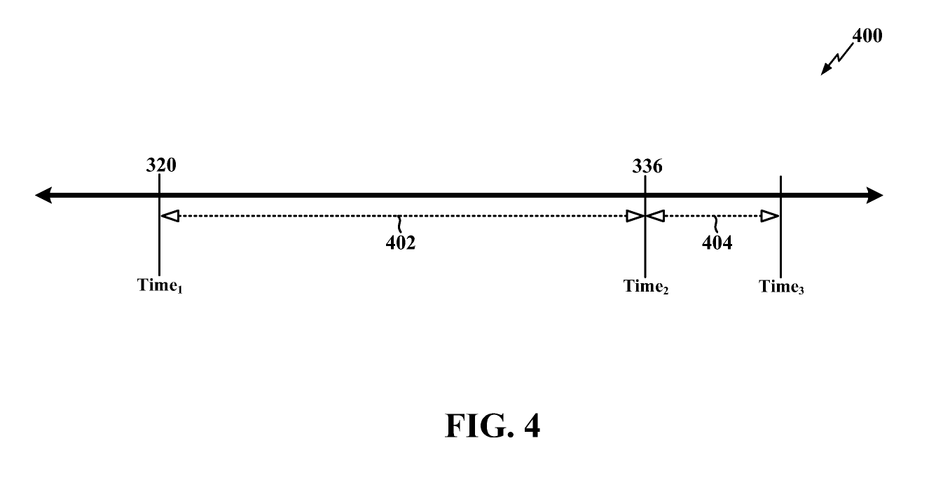

FIG. 4 is a diagram 400 illustrating an example of a timeline according to various aspects of the present disclosure. At Time₁, the data packet is at the beginning 320 of a queue at the MAC layer 210 of Apparatus₁. In some configurations, the time duration 402 may be calculated utilizing Equation 1, as described in greater detail above. As described in greater detail above, various aspects of the present disclosure provide for setting the lifetime limit (e.g., MAC layer lifetime limit) based on the amount of time for the data packet at the MAC layer 210 of Apparatus₁ to reach the application layer 216 of Apparatus₂. As also described in greater detail above, conventional communication systems may assign the lifetime limit (e.g., MAC layer lifetime limit) at the beginning 320 of the MAC layer 210 of Apparatus₁ regardless of the amount of time that the data packet will spend in the aforementioned paths 322, 326, 334 (from the beginning 320 of the MAC layer 210 of Apparatus₁ to the beginning 328 of the MAC layer 224 of Apparatus₂). Accordingly, there may exist an extra time duration 404 between (i) the time (Time₂) at which the data packet should be discarded according to Equation 1, and (ii) the time (Time₃) at which the data packet might be discarded in conventional communication systems. In comparison to conventional communication systems, aspects of the present disclosure provide for setting the lifetime limit (e.g., MAC layer lifetime limit) of the data packet at Time₂ instead of Time₃, thereby allowing the data packet to be discarded sooner (e.g., at Time₂ instead of Time₃) by a particular duration 404.

Accordingly, aspects of the present disclosure facilitate discarding of the data packet at a time that is earlier (e.g., at Time₂) than the data packet might be discarded otherwise (e.g., at Time₃), while still ensuring that the data packet has a lifetime limit (e.g., MAC layer lifetime limit) that is still long enough for the data packet to travel the paths 322, 326, 334 from the MAC layer 210 of Apparatus₁ to the application layer 216 of Apparatus₂. Discarding data packets once their lifetime limit (e.g., MAC layer lifetime limit) has been reached helps to reduce contention and congestion in the communication system. Contention and congestion in the communication system can be reduced because discarded packets cannot congest transmission queues (e.g., queues at the MAC layer 210 of Apparatus₁) and are not transmitted, thereby reducing contention. If the lifetime limit (e.g., MAC layer lifetime limit) of a data packet is too long (e.g., longer than the period during which it is suitable for transmission), then the likelihood of that data packet causing congestion and contention increases. Accordingly, the likelihood of congestion and contention caused by that data packet may be reduced in certain circumstances by determining a reduced lifetime limit (e.g., MAC layer lifetime limit) for that data packet (e.g., A₁ 302), as described in greater detail above.

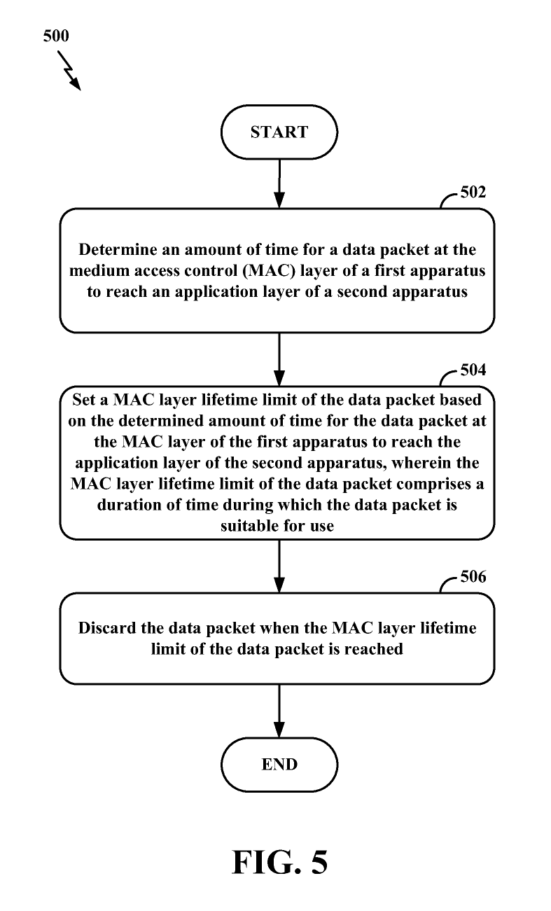

FIG. 5 is a diagram 500 illustrating an example of various methods and/or processes according to aspects of the present disclosure. Such methods and/or processes may be performed by an apparatus, such as Apparatus₁ and/or Apparatus₂, as described above. At block 502, the apparatus may determine an amount of time for a data packet at the MAC layer of a first apparatus to reach an application layer of a second apparatus. For example, referring to FIG. 3, Apparatus₁ may determine the amount of time for a data packet at the beginning 320 of a queue at the MAC layer 210 of Apparatus₁ to reach the beginning 336 of the application layer 216 of Apparatus₂. Such an amount of time may be calculated according to Equation 1, as described in greater detail above.

At block 504, the apparatus may set a lifetime limit (e.g., MAC layer lifetime limit) of the data packet based on the determined amount of time for the data packet at the MAC layer of the first apparatus to reach the application layer of the second apparatus. As described above, the lifetime limit (e.g., MAC layer lifetime limit) of the data packet includes a duration of time during which the data packet is suitable for transmission. For example, the determined amount of time may be the duration 402 illustrated in FIG. 4.

At block 506, the apparatus may discard the data packet when the lifetime limit (e.g., MAC layer lifetime limit) of the data packet is reached. For example, referring to FIG. 4, the data packet may be discarded at Time₂. In comparison to conventional communication systems, aspects of the present disclosure provide for setting the lifetime limit (e.g., MAC layer lifetime limit) of the data packet at Time₂ instead of Time₃, thereby allowing the data packet to be discarded sooner (e.g., at Time₂ instead of Time₃) by a particular duration 404. Discarding data packets once their lifetime limit (e.g., MAC layer lifetime limit) has been reached helps to reduce contention and congestion in the communication system. Contention and congestion in the overall system can be reduced because discarded packets cannot congest transmission queues (e.g., queues at the MAC layer 210 of Apparatus₁) and are not transmitted, thereby reducing contention.

The methods and/or processes described with reference to FIG. 5 are provided for illustrative purposes and are not intended to limit the scope of the present disclosure. The methods and/or processes described with reference to FIG. 5 may be performed in sequences different from those illustrated therein without deviating from the scope of the present disclosure. Additionally, some or all of the methods and/or processes described with reference to FIG. 5 may be performed individually and/or together without deviating from the scope of the present disclosure. It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

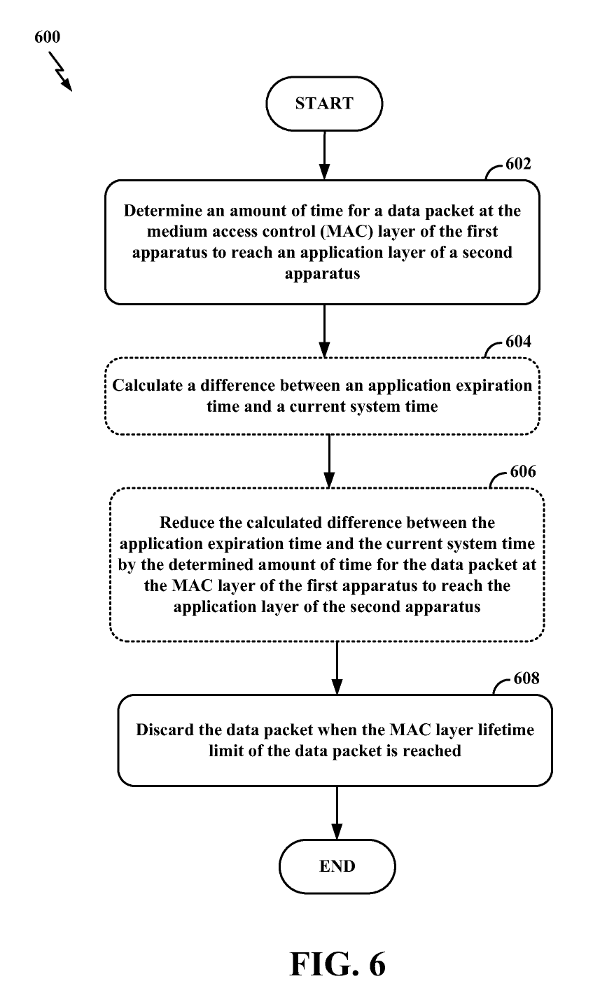

FIG. 6 is a diagram 600 illustrating an example of various methods and/or processes according to aspects of the present disclosure. Such methods and/or processes may be performed by an apparatus, such as Apparatus₁ and/or Apparatus₂, as described above. At block 602, the apparatus may determine an amount of time for a data packet at the MAC layer of a first apparatus to reach an application layer of a second apparatus. For example, referring to FIG. 3, Apparatus₁ may determine the amount of time for a data packet at the beginning 320 of a queue at the MAC layer 210 of Apparatus₁ to reach the beginning 336 of the application layer 216 of Apparatus₂. Such an amount of time may be calculated according to Equation 1, as described in greater detail above.

In some configurations, at block 604, the apparatus may calculate a difference between an application expiration time and a current system time. In some cases, the difference between an application expiration time (e.g., presentation time stamp) and the current system time can be represented by the following mathematical expression: PTS−SYS_Time_{Current}, wherein “PTS” refers to the application expiration time (e.g., presentation time stamp), and wherein “SYS_Time_{Current”} refers to the current system time (e.g., network time) when the data packet enters the MAC layer 210 (e.g., at the beginning 320 of the aforementioned path 322).

In some configurations, at block 606, the apparatus may reduce the calculated difference between the application expiration time and the current system time by the determined amount of time for the data packet at the MAC layer of the first apparatus to reach the application layer of the second apparatus. In some cases, the amount of time for the data packet at the MAC layer of an apparatus to reach the application layer of another apparatus can be represented by the following mathematical equation: Queue_Time_{MAC}+RTT_{MAC}+Time_Loss_{Misc}, wherein “Queue_Time_{MAC}” refers to the amount of time for the data packet to travel the aforementioned path 322, wherein “RTT_{MAC}” refers to the amount of time for the data packet to travel the aforementioned path 326, and wherein “Time_Loss_{Misc}” refers to the amount of time for the data packet to travel the aforementioned path 334. In such cases, the lifetime limit (e.g., MAC layer lifetime limit) (“MSDU_{Lifetime}_{_}_{Limit}”) of a data packet may be set utilizing the following mathematical expression: MSDU_{Lifetime}_{_}_{Limit}=PTS−SYS_Time_{Current}−Queue_Time_{MAC}−RTT_{MAC}−Time_Loss_{Misc}.

At block 608, the apparatus may discard the data packet when the lifetime limit (e.g., MAC layer lifetime limit) of the data packet is reached. Referring to FIG. 4, the data packet may be discarded at Time₂. In comparison to conventional communication systems, aspects of the present disclosure provide for setting the lifetime limit (e.g., MAC layer lifetime limit) of the data packet at Time₂ instead of Time₃, thereby allowing the data packet to be discarded sooner (e.g., at Time₂ instead of Time₃) by a particular duration 404. Discarding data packets once their lifetime limit (e.g., MAC layer lifetime limit) has been reached helps to reduce contention and congestion in the communication system. Contention and congestion in the communication system can be reduced because discarded packets cannot congest transmission queues (e.g., queues at the MAC layer 210 of Apparatus₁) and are not transmitted, thereby reducing contention.

The methods and/or processes described with reference to FIG. 6 are provided for illustrative purposes and are not intended to limit the scope of the present disclosure. The methods and/or processes described with reference to FIG. 6 may be performed in sequences different from those illustrated therein without deviating from the scope of the present disclosure. Additionally, some or all of the methods and/or processes described with reference to FIG. 6 may be performed individually and/or together without deviating from the scope of the present disclosure. It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

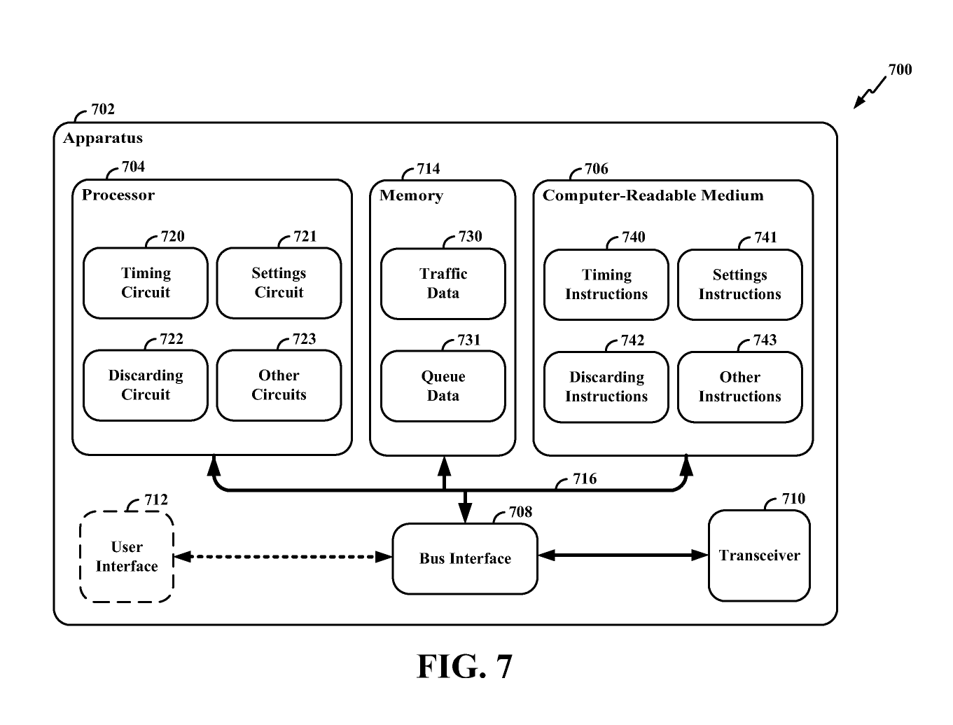

FIG. 7 is a diagram 700 illustrating an example of a hardware implementation of an apparatus 702 according to various aspects of the present disclosure. Generally, the apparatus 702 may be any device configured for wireless communication. In some configurations, the apparatus 702 may be Apparatus₁, and/or Apparatus₂, as described in greater detail above. The apparatus 702 may include a user interface 712. The user interface 712 may be configured to receive one or more inputs from a user of the apparatus 702. The user interface 712 may also be configured to display information to the user of the apparatus 702. The user interface 712 may exchange data via the bus interface 708.

The apparatus 702 may also include a transceiver 710. The transceiver 710 may be configured to receive data and/or transmit data in communication with another apparatus. The transceiver 710 provides a means for communicating with another apparatus via a wired or wireless transmission medium. The transceiver 710 may be configured to perform such communications using various types of technologies, such as IEEE 802.11. One of ordinary skill in the art will understand that many types of technologies may perform such communication without deviating from the scope of the present disclosure.

The apparatus 702 may also include a memory 714, one or more processors 704, a computer-readable medium 706, and a bus interface 708. The bus interface 708 may provide an interface between a bus 716 and the transceiver 710. The memory 714, the one or more processors 704, the computer-readable medium 706, and the bus interface 708 may be connected together via the bus 716. The processor 704 may be communicatively coupled to the transceiver 710 and/or the memory 714.

The processor 704 may include a timing circuit 720. The timing circuit 720 may include various hardware components and/or may perform various algorithms that provide the means for determining an amount of time for a data packet at the MAC layer of the first apparatus to reach an application layer of a second apparatus. The processor 704 may also include a settings circuit 721. The settings circuit 721 may include various hardware components and/or may perform various algorithms that provide the means for setting a lifetime limit (e.g., MAC layer lifetime limit) of the data packet based on the determined amount of time for the data packet at the MAC layer of the first apparatus to reach the application layer of the second apparatus. The processor 704 may also include a discarding circuit 722. The discarding circuit 722 may include various hardware components and/or may perform various algorithms that provide the means for discarding the data packet when the lifetime limit (e.g., MAC layer lifetime limit) of the data packet is reached. The foregoing description provides a non-limiting example of the processor 704 of the apparatus 702. Although various circuits 720, 721, 722 are described above, one of ordinary skill in the art will understand that the processor 704 may also include various other circuits 723 that are in addition and/or alternative(s) to the aforementioned circuits 720, 721, 722. Such other circuits 723 may provide the means for performing any one or more of the functions, methods, processes, features and/or aspects described herein.

The computer-readable medium 706 may include various computer-executable instructions. The computer-executable instructions may include computer-executable code configured to perform various functions and/or enable various aspects described herein. The computer-executable instructions may be executed by various hardware components (e.g., the processor 704 and/or any of its circuits 720, 721, 722, 723) of the apparatus 702. The computer-executable instructions may be a part of various software programs and/or software modules. The computer-readable medium 706 may include timing instructions 740. The timing instructions 740 may include computer-executable instructions configured for determining an amount of time for a data packet at the MAC layer of a first apparatus to reach an application layer of a second apparatus. The computer-readable medium 706 may also include settings instructions 741. The settings instructions 741 may include computer-executable instructions configured for setting a lifetime limit (e.g., MAC layer lifetime limit) of the data packet based on the determined amount of time for the data packet at the MAC layer of the first apparatus to reach the application layer of the second apparatus. The computer-readable medium 706 may include discarding instructions 742. The discarding instructions 742 may include computer-executable instructions configured for discarding the data packet when the lifetime limit (e.g., MAC layer lifetime limit) of the data packet is reached. The foregoing description provides a non-limiting example of the computer-readable medium 706 of the apparatus 702. Although various computer-executable instructions 740, 741, 742 are described above, one of ordinary skill in the art will understand that the computer-readable medium 706 may also include various other computer-executable instructions 743 that are in addition and/or alternative(s) to the aforementioned computer-executable instructions 740, 741, 742. Such other computer-executable instructions 743 may be configured for any one or more of the functions, methods, processes, features and/or aspects described herein.

The memory 714 may include various memory modules. The memory modules may be configured to store, and have read therefrom, various values and/or information by the processor 704, or any of its circuits 720, 721, 722, 723. The memory modules may also be configured to store, and have read therefrom, various values and/or information upon execution of the computer-executable code included in the computer-readable medium 706, or any of its instructions 740, 741, 742, 743. The memory 714 may include traffic data 730. The traffic data 730 may include data indicating traffic conditions and/or data types associated with (i) the data flowing from the application layer to the MAC layer of the first apparatus and/or (ii) the data flowing from the MAC layer to the application layer of the second apparatus. The traffic data 730 may be utilized to determine the amount of time for the data packet at the MAC layer of the first apparatus to reach the application layer of the second apparatus, as described in greater detail above. The memory 714 may also include queue data 731. The queue data 731 may include data indicating congestion at one or more queues at (i) the MAC layer of the first apparatus and/or (ii) the MAC layer of the second apparatus. The queue data 731 may be utilized to determine the amount of time for the data packet at the MAC layer of the first apparatus to reach the application layer of the second apparatus, as described in greater detail above. The foregoing description provides a non-limiting example of the memory 714 of the apparatus 702. Although various types of data of the memory 714 are described above, one of ordinary skill in the art will understand that the memory 714 may also include various other data that are in addition and/or alternative(s) to the aforementioned data 730, 731. Such other data may be associated with any one or more of the functions, methods, processes, features and/or aspects described herein.

One of ordinary skill in the art will also understand that the apparatus 702 may include alternative and/or additional features without deviating from the scope of the present disclosure. In accordance with various aspects of the present disclosure, an element, or any portion of an element, or any combination of elements may be implemented with a processing system that includes one or more processors 704. Examples of the one or more processors 704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. The processing system may be implemented with a bus architecture, represented generally by the bus 716 and bus interface 708. The bus 716 may include any number of interconnecting buses and bridges depending on the specific application of the processing system and the overall design constraints. The bus 716 may link together various circuits including the one or more processors 704, the memory 714, and the computer-readable medium 706. The bus 716 may also link various other circuits such as timing sources, peripherals, voltage regulators, and power management circuits, which are well known in the art.

The one or more processors 704 may be responsible for managing the bus 716 and general processing, including the execution of software stored on the computer-readable medium 706. The software, when executed by the one or more processors 704, causes the processing system to perform the various functions described below for any one or more apparatuses. The computer-readable medium 706 may also be used for storing data that is manipulated by the one or more processors 704 when executing software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 706. The computer-readable medium 706 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 706 may also include, by way of example, a carrier wave, a transmission line, and any other suitable medium for transmitting software and/or instructions that may be accessed and read by a computer. The computer-readable medium 706 may reside in the processing system, external to the processing system, or distributed across multiple entities including the processing system. The computer-readable medium 706 may be embodied in a computer program product. By way of example and not limitation, a computer program product may include a computer-readable medium in packaging materials. Those skilled in the art will recognize how best to implement the described functionality presented throughout this disclosure depending on the particular application and the overall design constraints imposed on the overall system.

The above description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

1. A method of wireless communication, the method comprising:
determining an amount of time for a data packet at a medium access control (MAC) layer of a first apparatus to reach an application layer of a second apparatus;
setting a MAC layer lifetime limit of the data packet based on the determined amount of time for the data packet at the MAC layer of the first apparatus to reach the application layer of the second apparatus, wherein the MAC layer lifetime limit of the data packet comprises a duration of time during which the data packet is suitable for transmission; and
discarding the data packet when the MAC layer lifetime limit of the data packet is reached.

2. The method of claim 1, wherein the setting the MAC layer lifetime limit of the data packet comprises:
calculating a difference between an application expiration time and a current system time; and
reducing the calculated difference between the application expiration time and the current system time by the determined amount of time for the data packet at the MAC layer of the first apparatus to reach the application layer of the second apparatus.

3. The method of claim 2, wherein the determined amount of time comprises:
an amount of time for the data packet at a beginning of a queue at the MAC layer of the first apparatus to reach an end of the queue at the MAC layer of the first apparatus.

4. The method of claim 3, wherein the determined amount of time further comprises:
an amount of time for the data packet at the end of the queue at the MAC layer of the first apparatus to reach a beginning of a queue at a MAC layer of the second apparatus.

5. The method of claim 4, wherein the determined amount of time further comprises:
an amount of time for the data packet at the beginning of the queue at the MAC layer of the second apparatus to reach the application layer of the second apparatus.

6. The method of claim 5, wherein the amount of time for the data packet at the beginning of the queue at the MAC layer of the second apparatus to reach the application layer of the second apparatus comprises:
an amount of time for the data packet at the beginning of the queue at the MAC layer of the second apparatus to reach an end of the queue at the MAC layer of the second apparatus.

7. The method of claim 1, wherein the MAC layer lifetime limit of the data packet is different from a MAC layer lifetime limit of another data packet associated with an access category that is the same as an access category with which the data packet is associated.

8. The method of claim 1, wherein the MAC layer lifetime limit of the data packet is different from a MAC layer lifetime limit of another data packet associated with a stream identifier that is the same as a stream identifier with which the data packet is associated.

9. A apparatus configured for wireless communication, the apparatus comprising:
a transceiver;
a memory; and
at least one processor communicatively coupled to the transceiver and the memory, wherein the at least one processor and the memory are configured to:
determine an amount of time for a data packet at a medium access control (MAC) layer of the apparatus to reach an application layer of another apparatus;
set a MAC layer lifetime limit of the data packet based on the determined amount of time for the data packet at the MAC layer of the apparatus to reach the application layer of the other apparatus, wherein the MAC layer lifetime limit of the data packet comprises a duration of time during which the data packet is suitable for transmission; and
discard the data packet when the MAC layer lifetime limit of the data packet is reached.

10. The apparatus of claim 9, wherein the setting the MAC layer lifetime limit of the data packet comprises:
calculating a difference between an application expiration time and a current system time; and
reducing the calculated difference between the application expiration time and the current system time by the determined amount of time for the data packet at the MAC layer of the apparatus to reach the application layer of the other apparatus.

11. The apparatus of claim 10, wherein the determined amount of time comprises:
an amount of time for the data packet at a beginning of a queue at the MAC layer of the apparatus to reach an end of the queue at the MAC layer of the apparatus.

12. The apparatus of claim 11, wherein the determined amount of time further comprises:
an amount of time for the data packet at the end of the queue at the MAC layer of the apparatus to reach a beginning of a queue at a MAC layer of the other apparatus.

13. The apparatus of claim 12, wherein the determined amount of time further comprises:
an amount of time for the data packet at the beginning of the queue at the MAC layer of the other apparatus to reach the application layer of the other apparatus.

14. The apparatus of claim 13, wherein the amount of time for the data packet at the beginning of the queue at the MAC layer of the other apparatus to reach the application layer of the other apparatus comprises:
an amount of time for the data packet at the beginning of the queue at the MAC layer of the other apparatus to reach an end of the queue at the MAC layer of the other apparatus.

15. The apparatus of claim 9, wherein the MAC layer lifetime limit of the data packet is different from a MAC layer lifetime limit of another data packet associated with an access category that is the same as an access category with which the data packet is associated.

16. The apparatus of claim 9, wherein the MAC layer lifetime limit of the data packet is different from a MAC layer lifetime limit of another data packet associated with a stream identifier that is the same as a stream identifier with which the data packet is associated.

17. A computer-readable medium storing computer-executable code comprising instructions configured for:
determining an amount of time for a data packet at a medium access control (MAC) layer of a first apparatus to reach an application layer of a second apparatus;
setting a MAC layer lifetime limit of the data packet based on the determined amount of time for the data packet at the MAC layer of the first apparatus to reach the application layer of the second apparatus, wherein the MAC layer lifetime limit of the data packet comprises a duration of time during which the data packet is suitable for transmission; and
discarding the data packet when the MAC layer lifetime limit of the data packet is reached.

18. The computer-readable medium of claim 17, wherein the setting the MAC layer lifetime limit of the data packet comprises:
calculating a difference between an application expiration time and a current system time; and
reducing the calculated difference between the application expiration time and the current system time by the determined amount of time for the data packet at the MAC layer of the first apparatus to reach the application layer of the second apparatus.

19. The computer-readable medium of claim 18, wherein the determined amount of time comprises:
an amount of time for the data packet at a beginning of a queue at the MAC layer of the first apparatus to reach an end of the queue at the MAC layer of the first apparatus.

20. The computer-readable medium of claim 19, wherein the determined amount of time further comprises:
an amount of time for the data packet at the end of the queue at the MAC layer of the first apparatus to reach a beginning of a queue at a MAC layer of the second apparatus.

21. The computer-readable medium of claim 20, wherein the determined amount of time further comprises:
an amount of time for the data packet at the beginning of the queue at the MAC layer of the second apparatus to reach the application layer of the second apparatus.

22. The computer-readable medium of claim 21, wherein the amount of time for the data packet at the beginning of the queue at the MAC layer of the second apparatus to reach the application layer of the second apparatus comprises:
an amount of time for the data packet at the beginning of the queue at the MAC layer of the second apparatus to reach an end of the queue at the MAC layer of the second apparatus.

23. The computer-readable medium of claim 17, wherein the MAC layer lifetime limit of the data packet is different from a MAC layer lifetime limit of another data packet associated with an access category that is the same as an access category with which the data packet is associated.

24. The computer-readable medium of claim 17, wherein the MAC layer lifetime limit of the data packet is different from a MAC layer lifetime limit of another data packet associated with a stream identifier that is the same as a stream identifier with which the data packet is associated.

25. An apparatus configured for wireless communication, the apparatus comprising:
means for determining an amount of time for a data packet at a medium access control (MAC) layer of a first apparatus to reach an application layer of a second apparatus;
means for setting a MAC layer lifetime limit of the data packet based on the determined amount of time for the data packet at the MAC layer of the first apparatus to reach the application layer of the second apparatus, wherein the MAC layer lifetime limit of the data packet comprises a duration of time during which the data packet is suitable for transmission; and
means for discarding the data packet when the MAC layer lifetime limit of the data packet is reached.

26. The apparatus of claim 25, wherein the setting the MAC layer lifetime limit of the data packet comprises:
calculating a difference between an application expiration time and a current system time; and
reducing the calculated difference between the application expiration time and the current system time by the determined amount of time for the data packet at the MAC layer of the first apparatus to reach the application layer of the second apparatus.

27. The apparatus of claim 26, wherein the determined amount of time comprises:
an amount of time for the data packet at a beginning of a queue at the MAC layer of the first apparatus to reach an end of the queue at the MAC layer of the first apparatus.

28. The apparatus of claim 27, wherein the determined amount of time further comprises:
an amount of time for the data packet at the end of the queue at the MAC layer of the first apparatus to reach a beginning of a queue at a MAC layer of the second apparatus.

29. The apparatus of claim 28, wherein the determined amount of time further comprises:
an amount of time for the data packet at the beginning of the queue at the MAC layer of the second apparatus to reach the application layer of the second apparatus.

30. The apparatus of claim 29, wherein the amount of time for the data packet at the beginning of the queue at the MAC layer of the second apparatus to reach the application layer of the second apparatus comprises:
an amount of time for the data packet at the beginning of the queue at the MAC layer of the second apparatus to reach an end of the queue at the MAC layer of the second apparatus.
